(19) United States
(12) Patent Application Publication
(10) Pub. No.: US 2025/0063600 A1
(43) Pub. Date: Feb. 20, 2025

(54) METHOD FOR DETERMINING SHARED CHANNEL OCCUPANCY TIME AND APPARATUSES THEREFOR

(71) Applicant: Beijing Xiaomi Mobile Software Co., Ltd., Beijing (CN)

(72) Inventor: Wensu ZHAO, Beijing (CN)

(73) Assignee: Beijing Xiaomi Mobile Software Co., Ltd., Beijing (CN)

(21) Appl. No.: 18/726,281

(22) PCT Filed: Jan. 6, 2022
(86) PCT No.: PCT/CN2022/070566

§ 371 Date: Jul. 2, 2024

(51) Int. Cl. H04W 74/0816; H04W 72/51; H04W 92/18

(52) U.S. Cl. CPC H04W 74/0816; H04W 72/51; H04W 92/18

(57) ABSTRACT

The present disclosure provides a method for determining shared channel occupancy time and an apparatuses therefor, which can be applied to an unlicensed frequency band in terminals' Sidelink communication. The method includes: based on a condition for sharing channel occupancy time (COT) between terminal devices, determining whether a first terminal device can share COT initiated by a second terminal device.

### CROSS-REFERENCE TO RELATED APPLICATIONS

The present disclosure is the U.S. national phase application of International Application No. PCT/CN2022/070566 filed on Jan. 6, 2022, the content of which is incorporated herein by reference in its entirety for all purposes.

### TECHNICAL FIELD

The present disclosure relates to the field of communication technology, in particular to a method for determining shared channel occupancy time (COT) and an apparatus therefor.

### BACKGROUND

With the continuous emergence of new communication services and application requirements, the terminals' Sidelink communication demands increasingly for transmission bandwidth, communication speed, communication delay, reliability, scalability and other performances. An unlicensed radio spectrum is needed as a supplement to the licensed radio spectrum to meet future diversified application scenarios and needs. Therefore, research on Sidelink communication technology on the unlicensed radio spectrum is urgent.

### SUMMARY

In a first aspect, the present disclosure provides a method for determining shared channel occupancy time, applied to an unlicensed frequency band in terminals' Sidelink communication and performed by a first terminal device, and the method includes: determining, based on a condition for sharing channel occupancy time (COT) between terminal devices, whether the first terminal device can share the COT initiated by a second terminal device.

In a second aspect, the present disclosure provides another method for determining shared channel occupancy time, applied to the unlicensed frequency band in terminals' Sidelink communication and performed by a second terminal device, and the method includes: sending COT sharing information to the first terminal device.

In a third aspect, the present disclosure provides a communication apparatus, applied to the unlicensed frequency band in terminals' Sidelink communication, including: a processing module configured to determine, based on a condition for sharing channel occupancy time (COT) between terminal devices, whether the first terminal device can share the COT initiated by a second terminal device.

In a fourth aspect, the present disclosure provides another communication apparatus, applied to the unlicensed frequency band in terminals' Sidelink communication, and the apparatus includes: a transceiver module configured to send COT sharing information to the first terminal device.

In a fifth aspect, the present disclosure provides a communication device including a processor, and when the processor calls a computer program in memory, the method described in the first aspect is caused to be implemented.

In a sixth aspect, the present disclosure provides a communication device including a processor, and when the processor calls a computer program in memory, the method described in the second aspect is caused to be implemented.

In a seventh aspect, the present disclosure provides a communication device including a processor and a memory, wherein a computer program is stored in the memory, and the processor is configured to execute the computer program stored in the memory to cause the communication device to implement the method described in the first aspect.

In an eighth aspect, the present disclosure provides a communication device including a processor and a memory, wherein a computer program is stored in the memory, and the processor is configured to execute the computer program stored in the memory to cause the communication device to implement the method described in the second aspect.

In a ninth aspect, the present disclosure provides a computer-readable storage medium having instructions stored thereon, which when executed, cause the first terminal device to perform the method described in the first aspect.

In a tenth aspect, the present disclosure provides a computer-readable storage medium having instructions stored thereon, which when executed, cause the second terminal device to perform the method described in the second aspect.

### BRIEF DESCRIPTION OF THE DRAWINGS

In order to provide a clearer explanation of the technical solutions in embodiments of the present disclosure or in the background, the drawings required for use in the embodiments or the background will be described in the following.

FIG. 1 is a schematic diagram of an architecture of a communication system according to embodiments of the present disclosure;

FIG. 2 is a flowchart of a method for determining shared channel occupancy time (COT) according to embodiments of the present disclosure;

FIG. 3 is a flowchart of a method for determining shared channel occupancy time (COT) according to embodiments of the present disclosure;

FIG. 4 is a flowchart of a method for determining shared channel occupancy time (COT) according to embodiments of the present disclosure;

FIG. 5 is a flowchart of a method for determining shared channel occupancy time (COT) according to embodiments of the present disclosure;

FIG. 6 is a flowchart of a method for determining shared channel occupancy time (COT) according to embodiments of the present disclosure;

FIG. 7 is a flowchart of a method for determining shared channel occupancy time (COT) according to embodiments of the present disclosure;

FIG. 8 is a flowchart of a method for determining shared channel occupancy time (COT) according to embodiments of the present disclosure;

FIG. 9 is a flowchart of a method for determining shared channel occupancy time (COT) according to embodiments of the present disclosure;

FIG. 10 is a flowchart of a method for determining shared channel occupancy time (COT) according to embodiments of the present disclosure;

FIG. 11 is a flowchart of a method for determining shared channel occupancy time (COT) according to embodiments of the present disclosure;

FIG. 12 is a schematic diagram of a structure of a communication apparatus according to embodiments of the present disclosure;

FIG. 13 is a schematic diagram of a structure of a communication apparatus according to embodiments of the present disclosure; and

FIG. 14 is a schematic diagram of a structure of a communication device 1400 according to embodiments of the present disclosure.

### DETAILED DESCRIPTION

Embodiments of the present disclosure will be described in the following in detail, examples of which are shown in the drawings, where the same or similar reference numerals throughout the disclosure represent the same or similar components or parts with same or similar functions. Embodiments described in the following with reference to the drawings are exemplary and are intended to be used to explain the present disclosure, but cannot be understood as limiting the present disclosure. In the description of the present disclosure, unless otherwise specified, “/” means “or”. For example, A/B can represent A or B. “And/or” in the present disclosure is only used for description of an association relationship between associated objects, which indicates that there can be three types of relationships. For example, A and/or B can represent A alone, both A and B, and B alone.

With the continuous emergence of new communication services and application requirements, the terminals' Sidelink communication demands increasingly for transmission bandwidth, communication speed, communication delay, reliability, scalability and other performances. An unlicensed radio spectrum is needed as a supplement to the licensed radio spectrum to meet future diversified application scenarios and needs. Therefore, research on Sidelink communication technology on the unlicensed radio spectrum is urgent.

In the related art, in order to meet the requirements for continuous channel occupancy time, the shared channel occupancy time (COT) is designed between the base station and the terminal device, and the terminals' Sidelink is deployed in the unlicensed frequency band. The terminal device needs to access the channel through Type 1 Listen Before Talk (LBT) each time, which usually takes a long time, has low efficiency, and has a low success rate.

In addition, there are problems in the proposed design of COT sharing between terminal devices. In a terminals' Sidelink communication system, there are multiple terminal devices around the terminal device that initiates the shared COT, and in both multicast and broadcast, these terminal devices around serve as receiving terminals of the terminal device that initiates the shared COT. Therefore, conflicts will occur when there are multiple terminal devices utilize the shared COT, resulting in the lower efficiency and the lower success rate of LBT.

Regarding the above issues, embodiments of the present disclosure provide a method and for determining shared channel occupancy time (COT) and an apparatus therefor. In order to better understand the method for determining shared channel occupancy time (COT) according to embodiments of the present disclosure, a communication system applicable to the embodiments of the present disclosure will first be described in the following.

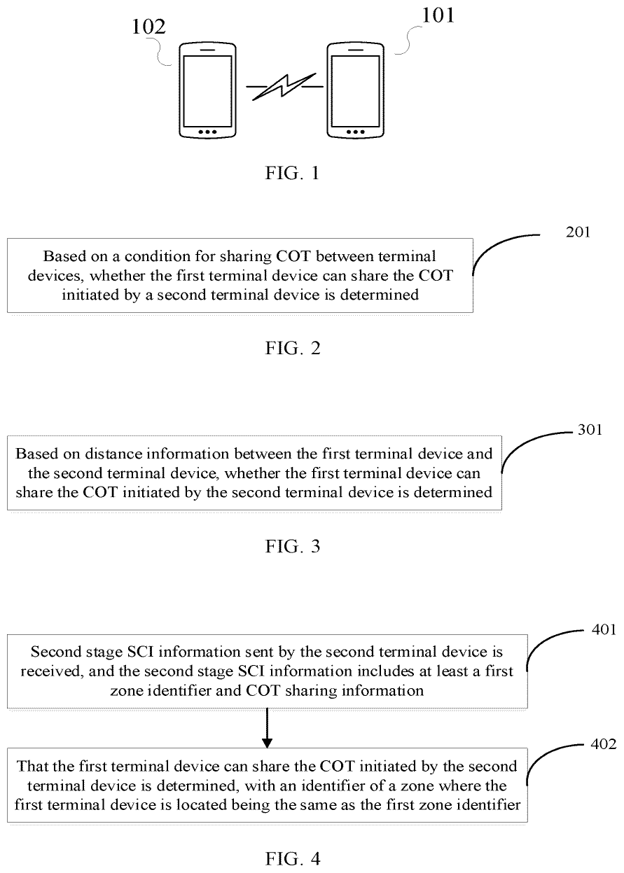

As shown in FIG. 1, a schematic diagram of an architecture of a communication system according to embodiments of the present disclosure is illustrated. The communication system can include but is not limited to two terminal devices, and the terminal devices communicate with each other through the Sidelink. The number and the form of devices shown in FIG. 1 are for example only and do not constitute a limitation on the embodiments of the present disclosure. The communication system shown in FIG. 1 takes inclusion of a first terminal device 101 and a second terminal device 102 as an example.

The first terminal device 101 and the second terminal device 102 in the embodiments of the present disclosure can be entities for receiving or emitting signals, for example, mobile phones. The terminal devices can also be referred to as terminals, user equipment (UE), mobile stations (MS), mobile terminals (MT), etc. The terminal devices can include cars with communication capabilities, smart cars, mobile phones, wearable devices, Pads, computers with wireless transceiver capabilities, virtual reality (VR) terminal devices, augmented reality (AR) terminal devices, wireless terminal devices in industrial control, wireless terminal devices in self-driving, wireless terminal devices in remote medical surgery, wireless terminal devices in smart grid, wireless terminal devices in transportation safety, wireless terminal devices in safety, wireless terminal devices in smart city, wireless terminal devices in smart home, and so on. Embodiments of the present disclosure do not limit the specific technology and device form adopted by the terminal device.

It can be understood that the communication system described in embodiments of the present disclosure is intended to provide a clearer explanation of technical solutions in the present disclosure, and does not constitute a limitation on the present disclosure. Those of ordinary skill in the art can realize that with the evolution of the system architecture and the emergence of new service scenarios, the technical solutions provided in the embodiments of the present disclosure is also applicable to similar technical problems.

A detailed introduction to the method for determining shared channel occupancy time (COT) and the apparatus therefor provided in the present disclosure will be provided in the following in conjunction with the drawings.

As shown in FIG. 2, a flowchart of the method for determining shared channel occupancy time (COT) according to embodiments of the present disclosure is illustrated. It should be noted that the method for determining shared COT according to embodiments of the present disclosure is applied to the unlicensed frequency band in the terminals' Sidelink communication, and the method is performed by a first terminal device. The first terminal device is a terminal device that shares the COT. As shown in FIG. 2, the method for determining shared COT can include but is not limited to the following steps.

In step 201, based on a condition for sharing COT between terminal devices, whether the first terminal device can share the COT initiated by a second terminal device is determined.

In some embodiments of the present disclosure, the second terminal device refers to the terminal device that initiates the shared COT. For example, the second terminal device can use Type 1 LBT to access the channel, initiate the COT being of a certain length, and send COT sharing information to the first terminal device. After receiving the COT sharing information sent by the second terminal device, the first terminal device determines, based on the condition for sharing COT between terminal devices, whether it can share the COT initiated by the second terminal device.

In some embodiments, the condition for sharing COT between terminal devices can be pre-defined in the terminals' Sidelink communication system. After receiving the COT sharing information sent by the second terminal device, the first terminal device can determine, based on the pre-defined COT sharing condition, whether it can share the COT initiated by the second terminal device. In addition, the condition for sharing COT between terminal devices can be determined based on actual application scenarios, which is not limited by the present disclosure.

In some embodiments, whether the first terminal device can share the COT initiated by the second terminal device can be determined based on distance information between the first terminal device and the second terminal device initiating the COT, so as to improve the success rate of data transmission.

In some embodiments, whether the first terminal device can share the COT initiated by the second terminal device can also be determined based on whether the first terminal device can use a time-frequency domain resource for the shared COT initiated by the second terminal device to send data, so as to ensure that the first terminal device can utilize the shared COT after receiving the shared COT.

In some embodiments, the identification information of the terminal device that can share the COT initiated by the second terminal device can also be pre-defined. After receiving the COT sharing information sent by the second terminal device, the first terminal device can compare itself with the pre-defined identification information of the terminal device to determine whether the COT initiated by the second terminal device can be shared.

According to the method for determining shared COT in embodiments of the present disclosure, the first terminal device determines, based on the condition for sharing COT between terminal devices, whether it can share the COT initiated by the second terminal device, so as to limit the first terminal devices that can share the COT initiated by the second terminal device, thereby improving the efficiency of the terminal device accessing the channel and ensuring the success rate of the terminal device using the shared COT to send data.

Based on the above embodiments of the present disclosure, another method for determining shared channel occupancy time (COT) is provided.

FIG. 3 is a flowchart of a method for determining shared channel occupancy time (COT) according to embodiments of the present disclosure. As shown in FIG. 3, the method can include but is not limited to the following steps.

In step 301, based on distance information between the first terminal device and the second terminal device, whether the first terminal device can share the COT initiated by the second terminal device is determined.

In some embodiments, the distance information between the first terminal device and the second terminal device can be zone information of respective zones where the first terminal device and the second terminal device are located, or the geographic distance between the first terminal device and the second terminal device, or other relevant information that can be used to represent the distance between the first terminal device and the second terminal device, which is not limited by the present disclosure.

According to embodiments of the present disclosure, based on the judgement of the distance information between the first terminal device and the second terminal device, it can be determined that the first terminal device closer to the second terminal device can share the COT initiated by the second terminal device, while the first terminal device farther away from the second terminal device cannot share the COT initiated by the second terminal device, thus ensuring the probability of successful transmission.

In some embodiments, after receiving Sidelink Control Information (SCI) from the second terminal device, the first terminal device can obtain the location information of the second terminal device carried in the SCI by decoding the SCI, and compare the location information of the first terminal device with the location information of the second terminal device. Based on a comparison result, whether the COT initiated by the second terminal device can be shared is determined.

According to the method for determining shared COT in embodiments of the present disclosure, the first terminal device determines, based on the distance information between the first terminal device and the second terminal device, whether it can share the COT initiated by the second terminal device. In this way, only the first terminal device closer to the second terminal device can share the COT initiated by the second terminal device, ensuring that the surrounding interference environment of the first terminal device sharing the COT is almost consistent with the surrounding interference environment of the second terminal device initiating the COT sharing, thereby improving the probability of successful data transmission and enhancing the effect of the COT sharing between terminal devices.

Based on the above embodiments, other embodiments are provided, for achieving that based on the distance information between the first terminal device and the second terminal device, whether the first terminal device can share the COT initiated by the second terminal device is determined.

FIG. 4 is a flowchart of a method for determining shared channel occupancy time (COT) according to embodiments of the present disclosure. As shown in FIG. 4, the method can include but is not limited to the following steps.

In step 401, second stage SCI information sent by the second terminal device is received, and the second stage SCI information includes at least a first zone identifier and COT sharing information.

In some embodiments of the present disclosure, the second stage SCI information sent by the second terminal device can include at least the first zone identifier and the COT sharing information. In some embodiments, the first zone identifier can be an identifier of the zone where the second terminal device is located. For example, the first zone identifier can be the zone ID (identity document) of the zone where the second terminal device is located. The COT sharing information can include at least one of a remaining length of the COT, identification information of the COT, or a channel access mode, so that the first terminal device can access the channel based on the received COT sharing information, achieving the sharing of the COT.

In some embodiments, the second stage SCI information sent by the second terminal device carries the first zone identifier and the COT sharing information. After receiving the second stage SCI information sent by the second terminal device, the first terminal device can parse the SCI information to obtain the identifier of the zone where the second terminal device is located and the COT sharing information, which are carried by the second terminal device.

In step 402, that the first terminal device can share the COT initiated by the second terminal device is determined, with an identifier of a zone where the first terminal device is located being the same as the first zone identifier.

It can be understood that if the identifier of the zone where the first terminal device is located is the same as the first zone identifier, it indicates that the first terminal device and the second terminal device are in the same zone. That is, the first terminal device and the second terminal device are geographically close, indicating that the surrounding interference environment of the first terminal device is basically the same as the surrounding interference environment of the second terminal device. Therefore, the probability of successful transmission by the first terminal device through the COT sharing initiated by the second terminal device is high, and thus the first terminal device can share the COT initiated by the second terminal device.

In some embodiments, the first terminal device decodes the SCI received from the second terminal device, obtains the zone ID of the zone where the second terminal device is located, and compares the zone ID of the zone where the second terminal device is located with the zone ID of the zone where the first terminal device itself is located. If the two zone IDs are consistent, it indicates that the first terminal device can share the COT initiated by the second terminal device, and thus can access the channel based on the COT sharing information.

According to the method for determining shared COT in embodiments of the present disclosure, the first terminal device obtains the zone identifier of the zone where the second terminal device is located based on the received second stage SCI information sent by the second terminal device. If the zone identifier of the first terminal device itself is consistent with the zone identifier of the second terminal device, the first terminal device can share the COT. That is, whether the first terminal device is close to or far away from the second terminal device in the geographic distance is determined based on whether zone identifier of the first terminal device itself is consistent with the zone identifier of the second terminal device, so as to determine whether the first terminal device can share the COT initiated by the second terminal device. As a result, not only the probability of successful data transmission can be improved, but also the effect of the COT sharing between terminal devices can be enhanced.

Based on the above embodiments, other embodiments are provided, for achieving that based on the distance information between the first terminal device and the second terminal device, whether the first terminal device can share the COT initiated by the second terminal device is determined.

FIG. 5 is a flowchart of a method for determining shared channel occupancy time (COT) according to embodiments of the present disclosure. As shown in FIG. 5, the method can include but is not limited to the following steps.

In step 501, second stage SCI information sent by the second terminal device is received, and the second stage SCI information includes at least a second zone identifier.

In some embodiments, the second stage SCI information sent by the second terminal device can include at least the second zone identifier. In some embodiments, second zone identifier can be an identifier of the zone where the second terminal device is located. For example, the second zone identifier can be the zone ID of the zone where the second terminal device is located. In addition, the second stage SCI information sent by the second terminal device can also include the COT sharing information, and the COT sharing information can include at least one of a remaining length of the COT, identification information of the COT, or a channel access mode, so that the first terminal device can access the channel based on the received COT sharing information, achieving the sharing of the COT.

In some embodiments, after receiving the second stage SCI information sent by the second terminal device, the first terminal device can parse the SCI information to obtain the identifier of the zone where the second terminal device is located.

In step 502, based on the second zone identifier, a distance between the first terminal device and the second terminal device is determined.

In some embodiments, the geographic location information of the second terminal device can be determined based on the second zone identifier. The distance between the first terminal device and the second terminal device can be determined based on the geographic location information of the first terminal device and the geographic location information of the second terminal device.

In some embodiments, if the second zone identifier is the zone ID of the zone where the second terminal device is located, x₁ and/or y₁ corresponding to the second zone identifier can be obtained by looking up a table, the geographic location coordinate information of the second terminal device can be calculated based on the following formulas (1), (2), and (3), and the distance between the first terminal device and the second terminal device can be calculated based on the following formula (4).

$${x}_{1} = Floor ( \frac{x}{L} ) Mod 64 , \qquad ( 1 )$$

$${y}_{1} = Floor ( \frac{y}{L} ) Mod 64 , \qquad ( 2 )$$

$$zone ID = 64 {y}_{1} + {x}_{1} , \qquad ( 3 )$$

where the zone ID is identifier of the zone where the second terminal device is located; x₁ and/or y₁ can be obtained by looking up a table based on the zone ID; L is a pre-configured length of the zone (the zone is a square); x is the geodesic longitude distance between the current position of the second terminal device and the geographic coordinates (0, 0), which is the longitude value of the second terminal device in the geographic coordinate system; y is the geodesic latitude distance between the current position of the second terminal device and the geographic coordinates (0, 0), which is the latitude value of the second terminal device in the geographic coordinate system.

$$M = \sqrt{{( x - {x}_{2} )}^{2} + {( y - {y}_{2} )}^{2}} , \qquad ( 4 )$$

where M is the distance between the first terminal device and the second terminal device; x is the longitude value of the second terminal device in the geographic coordinate system; y is the latitude value of the second terminal device in the geographic coordinate system; x₂ is the longitude value of the first terminal device in the geographic coordinate system; y₂ is the latitude value of the first terminal device in the geographic coordinate system.

In step 503, that the first terminal device can share the COT initiated by the second terminal device is determined, with the distance between the first terminal device and the second terminal device being less than a distance threshold, or the distance between the first terminal device and the second terminal device being within a pre-configured distance range.

In some embodiments, the distance threshold or the distance range can be configured in advance according to the requirements of actual application scenarios. If the distance between the first terminal device and the second terminal device is less than the distance threshold, or the distance between the first terminal device and the second terminal device is within the pre-configured distance range, it indicates that the first terminal device is close to the second terminal device, and the surrounding interference environment of the first terminal device is basically the same as the surrounding interference environment of the second terminal device, which also indicates that the probability of successful transmission by the first terminal device through the COT sharing initiated by the second terminal device is high, and thus the first terminal device can share the COT initiated by the second terminal device.

According to the method for determining shared COT in embodiments of the present disclosure, the first terminal device obtains the zone identifier of the zone where the second terminal device is located based on the second stage SCI information sent by the second terminal device, and determines the distance between the first terminal device and the second terminal device based on the zone identifier. If the distance is less than the preset threshold or within the preset distance range, the first terminal device can share the COT. That is, based on the zone identifier of the zone where the second terminal device is located, the distance between the first terminal device and the second terminal device is determined. If the distance meets the predefined conditions, the COT initiated by the second terminal device can be shared. As a result, not only the probability of successful data transmission can be improved, but also the effect of the COT sharing between terminal devices can be enhanced.

Based on the above embodiments, other embodiments are provided, for achieving that based on the distance information between the first terminal device and the second terminal device, whether the first terminal device can share the COT initiated by the second terminal device is determined.

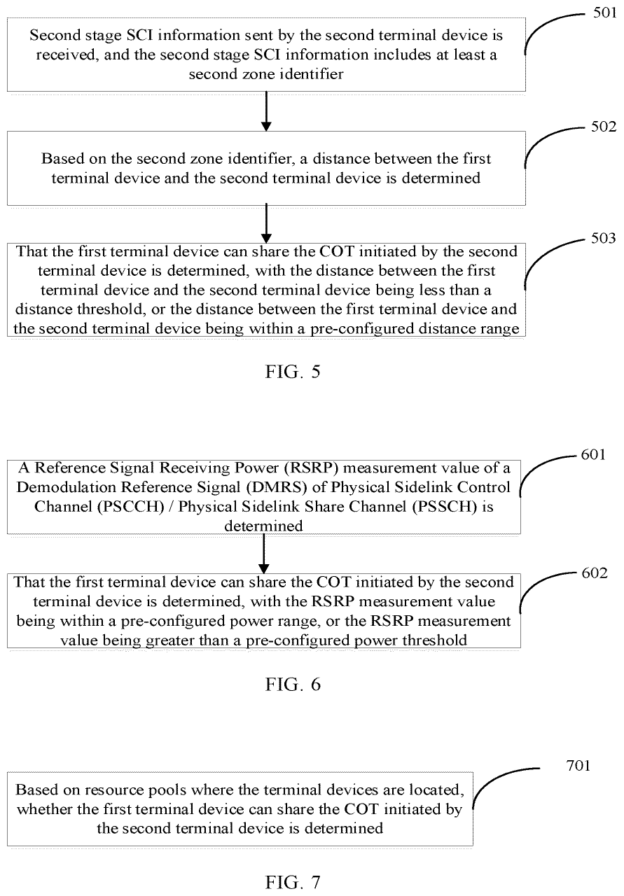

FIG. 6 is a flowchart of a method for determining shared channel occupancy time (COT) according to embodiments of the present disclosure. As shown in FIG. 6, the method can include but is not limited to the following steps.

In step 601, a Reference Signal Receiving Power (RSRP) measurement value of a Demodulation Reference Signal (DMRS) of Physical Sidelink Control Channel (PSCCH)/Physical Sidelink Share Channel (PSSCH) is determined.

It should be noted that when receiving the SCI sent by the second terminal device, the first terminal device would perform Reference Signal Receiving Power (RSRP) measurement on the Demodulation Reference Signal (DMRS) of Physical Sidelink Control Channel (PSCCH)/Physical Sidelink Share Channel (PSSCH), so as to determine the RSRP measurement value.

In step 602, that the first terminal device can share the COT initiated by the second terminal device is determined, with the RSRP measurement value being within a pre-configured power range, or the RSRP measurement value being greater than a pre-configured power threshold.

It can be understood that if the RSRP measurement value is within the pre-configured power range, or if the RSRP measurement value is greater than the pre-configured power threshold, it indicates that the power loss during the SCI transmission is relatively small, which can indicate that the first terminal device is close to the second terminal device, and the surrounding interference environment of the first terminal device is almost consistent with the surrounding interference environment of the second terminal device. In this way, the probability of successful transmission by the first terminal device through the COT sharing initiated by the second terminal device is high, and thus the first terminal device can share the COT initiated by the second terminal device.

According to the method for determining shared COT in embodiments of the present disclosure, based on the RSRP measurement value of the DMRS of PSCCH/PSSCH, if the RSRP measurement value is within the pre-configured power range, or if the RSRP measurement value is greater than the pre-configured power threshold, the first terminal device can share the COT initiated by the second terminal device. That is, based on the RSRP measurement value, the distance between the first terminal device and the second terminal device can be obtained, so as to determine whether the first terminal device can share the COT initiated by the second terminal device, thereby improving the probability of successful data transmission and enhancing the effect of the COT sharing between terminal devices.

The condition for sharing COT between terminal devices can not only be a condition such as distance information between terminal devices, but also a constraint condition based on other information. Some embodiments of the present disclosure will also be provided in the following.

FIG. 7 is a flowchart of a method for determining shared channel occupancy time (COT) according to embodiments of the present disclosure. As shown in FIG. 7, the method can include but is not limited to the following steps.

In step 701, based on resource pools where the terminal devices are located, whether the first terminal device can share the COT initiated by the second terminal device is determined.

In some embodiments, the SCI information sent by the second terminal device to the first terminal device can carry information about the resource pool where the second terminal device is located, so the first terminal device can decode the received SCI information to obtain the information about the resource pool where the second terminal device is located. The first terminal device compares its own resource pool with the resource pool of the second terminal device, so as to determine whether the first terminal device can share the COT initiated by the second terminal device.

In some embodiments of the present disclosure, the step 701 can be executed as follows: determining that the first terminal device can share the COT initiated by the second terminal device, with a first resource pool where the first terminal device is located being the same as a second resource pool where the second terminal device is located.

It can be understood that if the first resource pool where the first terminal device is located is consistent with the second resource pool where the second terminal device is located, it indicates that the time-frequency domain resource for the COT initiated by the second terminal device is the same as the time-frequency domain resource in the first resource pool where the first terminal device is located. That is, the first terminal device can use the time-frequency domain resource for the COT initiated by the second terminal device for data transmission. If the first resource pool where the first terminal device is located is inconsistent with the second resource pool where the second terminal device is located, it indicates that the time-frequency domain resource for the COT initiated by the second terminal device is different from the time-frequency domain resource in the first resource pool where the first terminal device is located. That is, the first terminal device would not use the time-frequency domain resource for the COT initiated by the second terminal device for data transmission. Therefore, only when the first resource pool where the first terminal device is located is the same as the second resource pool where the second terminal device is located, can the first terminal device share the COT initiated by the second terminal device, thereby ensuring the probability of successful data transmission.

According to the method for determining shared COT in embodiments of the present disclosure, based on the resource pools where the terminal devices are located, whether the first terminal device can share the COT initiated by the second terminal device is determined, so as to limit the first terminal devices that can share the COT initiated by the second terminal device, thereby improving the efficiency of the terminal device accessing the channel and ensuring the success rate of the terminal device using the shared COT to send data.

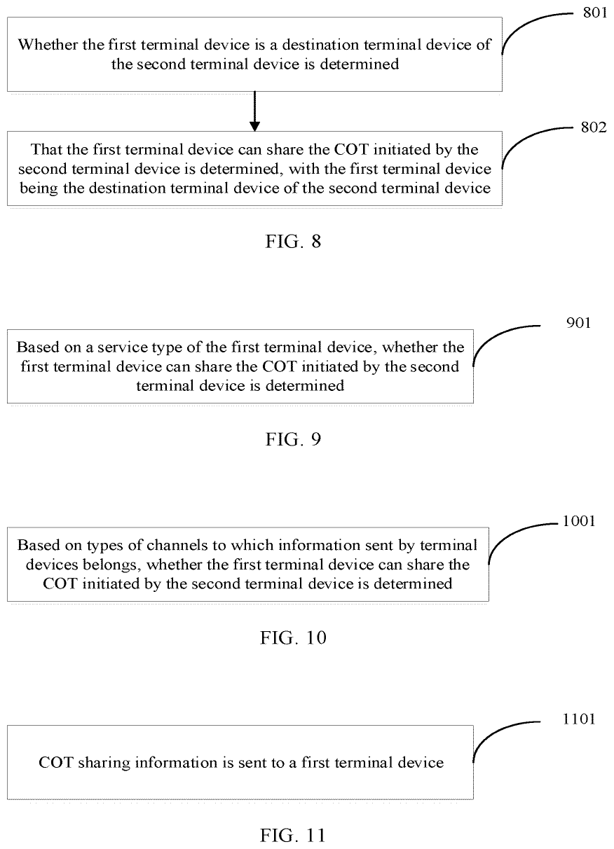

FIG. 8 is a flowchart of a method for determining shared channel occupancy time (COT) according to embodiments of the present disclosure. As shown in FIG. 8, the method can include but is not limited to the following steps.

In step 801, whether the first terminal device is a destination terminal device of the second terminal device is determined.

In some embodiments of the present disclosure, for multicast and broadcast application scenarios, when the second terminal device sends the SCI information to the first terminal device, identification information of the destination terminal device can be carried. In some embodiments, the identification information of the destination terminal device can be the destination ID information, and the field of the information is carried through the first stage SCI. The identification information of the destination terminal device is the identification information of the terminal device that can share the COT initiated by the second terminal device.

In some embodiments, the first terminal device receives the SCI information sent by the second terminal device and decodes the SCI information to obtain the identification information of the destination terminal device of the second terminal device, namely the destination ID information. The first terminal device compares the identification information of itself with the identification information of the destination terminal device. If the identification information of the first terminal device is consistent with the identification information of the destination terminal device, then the first terminal device is the destination terminal device of the second terminal device. If the identification information of the first terminal device is inconsistent with the identification information of the destination terminal device, then the first terminal device is not the destination terminal device of the second terminal device.

In step 802, that the first terminal device can share the COT initiated by the second terminal device is determined, with the first terminal device being the destination terminal device of the second terminal device.

According to the method for determining shared COT in embodiments of the present disclosure, by determining whether the first terminal device is the destination terminal device of the second terminal device, whether the first terminal device can share the COT initiated by the second terminal device can be determined, so as to limit the first terminal devices that can share the COT initiated by the second terminal device, thereby ensuring the success rate of the terminal device using the shared COT to send data and enhancing the effect of the COT sharing between terminal devices.

FIG. 9 is a flowchart of a method for determining shared channel occupancy time (COT) according to embodiments of the present disclosure. As shown in FIG. 9, the method can include but is not limited to the following steps.

In step 901, based on a service type of the first terminal device, whether the first terminal device can share the COT initiated by the second terminal device is determined.

In some embodiments of the present disclosure, the service type of the first terminal device that can share the COT initiated by the second terminal device can be pre-defined, and the first terminal device determines, based on its own service type, whether the COT initiated by the second terminal device can be shared.

In some embodiments, the first terminal device is determined to be able to share the COT sent by the second terminal device, with the service type of the first terminal device being a target service type. In addition, the target service type is the pre-configured service type of the first terminal device that can share the COT initiated by the second terminal device, which can include at least any of a unicast service, a multicast service, or a broadcast service.

According to the method for determining shared COT in embodiments of the present disclosure, based on the service type of the first terminal device, whether the first terminal device can share the COT initiated by the second terminal device is determined, so as to limit the first terminal devices that can share the COT initiated by the second terminal device, thereby ensuring the success rate of the terminal device using the shared COT to send data and enhancing the effect of the COT sharing between terminal devices.

FIG. 10 is a flowchart of a method for determining shared channel occupancy time (COT) according to embodiments of the present disclosure. As shown in FIG. 10, the method can include but is not limited to the following steps.

In step 1001, based on types of channels to which information sent by the terminal devices belongs, whether the first terminal device can share the COT initiated by the second terminal device is determined.

It can be understood that the type of the channel to which the information sent by the terminal device belongs should be consistent with the type of the channel to which it accesses, so as to achieve successful information transmission. That is, if the COT initiated by the second terminal device is Physical Sidelink Feedback Channel (PSFCH), only the first terminal device that sends the information having a type of PSFCH as well can use the COT for data transmission. If the COT initiated by the second terminal device is the PSSCH, only the first terminal device that sends the information having a type of PSSCH as well can use the COT for data transmission.

In some embodiments, the first terminal device is determined to be able to share the COT initiated by the second terminal device, with the type of the channel to which the information sent by the first terminal device belongs being the same as the type of the channel to which the information sent by the second terminal device belongs. That is, the first terminal device knows the type of the channel (such as control channel, feedback channel, data channel) to which the information it is to send belongs, receives the information sent by the second terminal device, obtains the type of the channel to which the information sent by the second terminal device belongs, and compares the types of the channels. If the types of the two channels are consistent, the first terminal device can share the COT initiated by the second terminal device, thereby improving the success rate of the COT sharing between terminal devices.

According to the method for determining shared COT in embodiments of the present disclosure, based on the types of the channels to which the information sent by the terminal devices belongs, whether the first terminal device can share the COT initiated by the second terminal device is determined, so as to limit the first terminal devices that can share the COT initiated by the second terminal device, thereby improving the success rate of the COT sharing between terminal devices.

In order to achieve the above methods, the present disclosure also provides another method for determining shared channel occupancy time (COT), which is applied to the unlicensed frequency band in the terminals' Sidelink communication, and the method is performed by a second terminal device, that is, the terminal device that initiates the COT sharing.

FIG. 11 is a flowchart of a method for determining shared channel occupancy time (COT) according to embodiments of the present disclosure. As shown in FIG. 11, the method can include but is not limited to the following steps.

In step 1101, COT sharing information is sent to a first terminal device.

In some embodiments, the COT sharing information can include at least one of a remaining length of the COT, a unique ID (identity document) of the COT, or a channel access mode.

In some embodiments, the second terminal device can use Type 1 LBT mode to access the channel, and initiate a certain length of COT. The second terminal device can determine the remaining length of the COT according to specific situations, and carry the COT sharing information including at least one of a remaining length of the COT, a COT ID, or a channel access mode when communicating with the first terminal device in Sidelink.

When receiving the COT sharing information sent by the second terminal device, the first terminal device can determine, based on the condition for sharing COT between terminal devices, whether it can share the COT initiated by the second terminal device. In some embodiments, determining whether the first terminal device can share the COT initiated by the second terminal device can be implemented according to any of the above embodiments shown in FIGS. 2 to 10. The present disclosure does not limit this and will not be repeated here.

According to the method for determining shared COT in embodiments of the present disclosure, the second terminal device sends the COT sharing information to the first terminal device, so that the first terminal device can receive the COT sharing information, thereby achieving the COT sharing between terminal devices, improving the frequency band utilization, and meeting communication service requirements.

The methods provided in embodiments of the present disclosure are introduced from the perspectives of the first terminal device and the second terminal device, respectively. In order to achieve the various functions of the methods provided in embodiments of the present disclosure, the first terminal device and the second terminal device can include hardware structures and software modules, which are implemented in the form of hardware structures, software modules, or the hardware structures and the software modules. One of the above functions can be achieved in the form of hardware structures, software modules, or the hardware structures and the software modules.

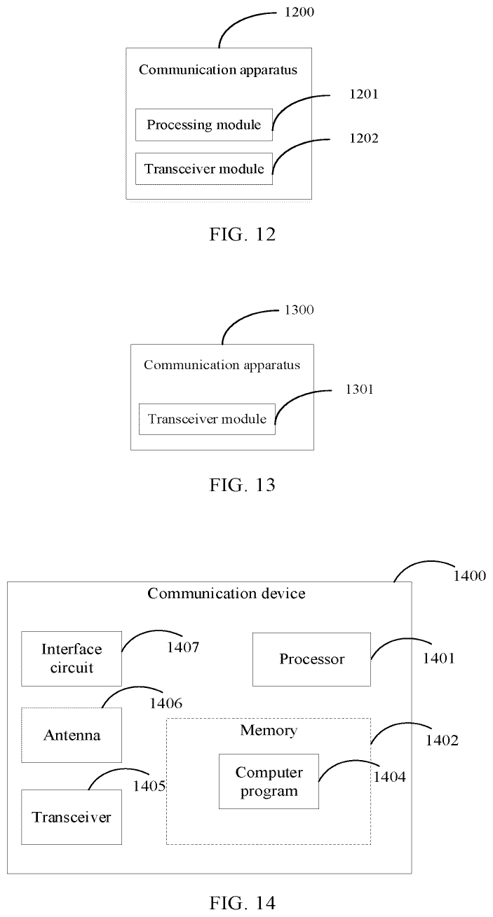

FIG. 12 is a schematic diagram of a structure of a communication apparatus according to embodiments of the present disclosure. It should be noted that the apparatus is applied to the unlicensed frequency band in terminals' Sidelink communication. The apparatus can be the first terminal device, or a means within the first terminal device, or a means that can be matched and operated with the first terminal device. The communication apparatus shown in FIG. 12 can include a processing module 1201.

In some embodiments of the present disclosure, the processing module 1201 is configured to determine, based on a condition for sharing channel occupancy time (COT) between terminal devices, whether the first terminal device can share the COT initiated by a second terminal device.

In some embodiments, the processing module 1201 is further configured to: determine, based on distance information between the first terminal device and the second terminal device, whether the first terminal device can share the COT initiated by the second terminal device.

In some embodiments, the apparatus further includes a transceiver module 1202, and the transceiver module 1202 is configured to receive second stage SCI sent by the second terminal device, the second stage SCI including at least a first zone identifier and COT sharing information.

In some embodiments, the processing module 1201 is further configured to determine that the first terminal device can share the COT initiated by the second terminal device, with an identifier of a zone where the first terminal device is located being the same as the first zone identifier.

In some embodiments, the apparatus further includes a transceiver module 1202, and the transceiver module 1202 is configured to receive second stage SCI sent by the second terminal device, the second stage SCI including at least a second zone identifier.

In some embodiments, the processing module 1201 is further configured to: determine, based on the second zone identifier, a distance between the first terminal device and the second terminal device; and determine that the first terminal device can share the COT initiated by the second terminal device, with the distance being less than a distance threshold or within a pre-configured distance range.

In some embodiments, the processing module 1201 is further configured to: determine, based on the second zone identifier, geographic location information of the second terminal device; and determine, based on geographic location information of the first terminal device and the geographic location information of the second terminal device, the distance between the first terminal device and the second terminal device.

In some embodiments, the processing module 1201 is further configured to: determine a Reference Signal Receiving Power (RSRP) measurement value of a Demodulation Reference Signal (DMRS) of Physical Sidelink Control Channel (PSCCH)/Physical Sidelink Share Channel (PSSCH); and determine that the first terminal device can share the COT initiated by the second terminal device, with the RSRP measurement value being within a pre-configured power range, or greater than a pre-configured power threshold.

In some embodiments, the processing module 1201 is further configured to: determine, based on resource pools where the terminal devices are located, whether the first terminal device can share the COT initiated by the second terminal device.

In some embodiments, the processing module 1201 is further configured to: determine that the first terminal device can share the COT initiated by the second terminal device, with a first resource pool where the first terminal device is located being the same as a second resource pool where the second terminal device is located.

In some embodiments, the processing module 1201 is further configured to: determine whether the first terminal device is a destination terminal device of the second terminal device; and determine that the first terminal device can share the COT initiated by the second terminal device, with the first terminal device being the destination terminal device of the second terminal device.

In some embodiments, the processing module 1201 is further configured to: determine, based on a service type of the first terminal device, whether the first terminal device can share the COT initiated by the second terminal device.

In some embodiments, the processing module 1201 is further configured to: determine that the first terminal device can share the COT sent by the second terminal device, with the service type of the first terminal device being a target service type.

In some embodiments, the target service type includes at least any one of a unicast service, a multicast service, or a broadcast service.

In some embodiments, the processing module 1201 is further configured to: determine, based on types of channels to which information sent by the terminal devices belongs, whether the first terminal device can share the COT initiated by the second terminal device.

In some embodiments, the processing module 1201 is further configured to: determine that the first terminal device can share the COT initiated by the second terminal device, with a type of a channel to which information sent by the first terminal device belongs being the same as a type of a channel to which information sent by the second terminal device belongs.

According to the communication apparatus in embodiments of the present disclosure, based on the condition for sharing COT between terminal devices, whether the first terminal device can share the COT initiated by the second terminal device is determined, so as to limit the first terminal devices that can share the COT initiated by the second terminal device, thereby improving the efficiency of the terminal device accessing the channel and ensuring the success rate of the terminal device using the shared COT to send data.

FIG. 13 is a schematic diagram of a structure of a communication apparatus according to embodiments of the present disclosure. It should be noted that the communication apparatus can be applied to the unlicensed frequency band in terminals' Sidelink communication. The communication apparatus can be a second terminal device, or a means within the second terminal device, or a means that can be matched and operated with the second terminal device. As shown in FIG. 13, the communication apparatus can include a transceiver module 1301.

In some embodiments of the present disclosure, the transceiver module 1301 is configured to send COT sharing information to the first terminal device.

According to the communication apparatus in embodiments of the present disclosure, the communication apparatus sends the shared the COT sharing information to the first terminal device, so that the first terminal device can receive the COT sharing information, thereby achieving the COT sharing between terminal devices, improving the frequency band utilization, and meeting communication service requirements.

FIG. 14 is a schematic diagram of a structure of a communication device 1400 according to embodiments of the present disclosure. The communication device 1400 can be the first terminal device or the second terminal device in the aforementioned method embodiments, and communication device 1400 can also be a chip, a chip system, or a processor that supports the terminal device to implement the above methods. The device can be used to implement the methods described in the above method embodiments. Specifically, reference can be made to the description in the above method embodiments.

The communication device 1400 can include one or more processors 1401. The processor 1401 can be a general-purpose processor or a dedicated processor, etc. For example, the processor can be a baseband processor or a central processor. The baseband processor can be used to process communication protocols and communication data, and the central processor can be used to control the communication device (such as base stations, baseband chips, terminal devices, terminal device chips, DU or CU, etc.), execute computer programs, and process computer program data.

In some embodiments, the communication device 1400 can also include one or more memories 1402, and a computer program 1404 can be stored on the memory. The processor 1401 can execute the computer program 1404 to cause the communication device 1400 to implement the methods described in the above embodiments. In some embodiments, the memory 1402 can also store data. The communication device 1400 and the memory 1402 can be arranged separately or integrated together.

In some embodiments, the communication device 1400 can also include a transceiver 1405 and an antenna 1406. The transceiver 1405 can be referred to as a transceiver unit, a transceiver machine, or a transceiver circuit, etc., and can be used to achieve a transceiving function. The transceiver 1405 can include a receiver and a transmitter. The receiver can be referred to as a receiver or a receiver circuit, etc., and is used to achieve a receiving function. The transmitter can be referred to as a transmitter or a transmitter circuit, etc., and is used to achieve a transmitting function.

In some embodiments, the communication device 1400 can also include one or more interface circuits 1407. The interface circuit 1407 is used to receive code instructions and transmit the code instructions to the processor 1401. The processor 1401 executes the code instructions to cause the communication device 1400 to implement the methods described in the above method embodiments.

The communication device 1400 is the second terminal device in aforementioned method embodiments, and the transceiver 1405 is used to execute step 1101 in FIG. 11.

The communication device 1400 is the first terminal device in aforementioned method embodiments, the processor 1401 is used to execute step 201 in FIG. 2, step 301 in FIG. 3, step 402 in FIG. 4, steps 502 and 503 in FIG. 5, steps 601 and 602 in FIG. 6, step 701 in FIG. 7, steps 801 and 802 in FIG. 8, step 901 in FIG. 9, and step 1001 in FIG. 10, and the transceiver 1405 is used to step 401 in FIG. 4, and step 501 in FIG. 5.

In some embodiments, the processor 1401 can include a transceiver for achieving receiving and transmitting functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing codes/data, or the above-mentioned transceiver circuit, interface or interface circuit can be used for transmitting or transferring signals.

In some embodiments, the processor 1401 can store a computer program 1403, which runs on the processor 1401 and causes the communication device 1400 to implement the methods described in the above embodiments. The computer program 1403 can be embedded in processor 1401, in which case the processor 1401 can be realized through hardware.

In some embodiments, the communication device 1400 can include a circuit that can achieve receiving, transmitting, or communicating functions as described in the above method embodiments. The processor and the transceiver described in the present disclosure can be realized on the integrated circuit (IC), analog IC, radio frequency integrated circuit (RFIC), mixed signal IC, application specific integrated circuit (ASIC), printed circuit board (PCB), electronic device, and the like. The processor and the transceiver can also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device described in the above embodiments can be a network device or a terminal device, but the communication device described in the present disclosure is not limited to this, and the structure of the communication device may not be limited by FIG. 14. The communication device can be an independent device or can be part of a larger device. For example, the communication device can be at least one of:
(1) Independent integrated circuit ICs, or chips, or chip systems or subsystems.
(2) A set including one or more ICs, which can optionally also include storage components for storing data and computer programs.
(3) ASICs, for example, a modem.
(4) Modules that can be embedded in other devices.
(5) Receivers, terminal devices, intelligent terminal devices, cellular phones, wireless devices, handheld devices, mobile units, vehicle mounted devices, network devices, cloud devices, artificial intelligence devices, etc.
(6) Other devices and so on.

Those skilled in the art can also understand that the various illustrative logical blocks and steps listed in the embodiments of the present disclosure can be achieved through electronic hardware, computer software, or a combination of both. Whether a function is achieved through hardware or software depends on the specific application and design requirements of the overall system. Those skilled in the art can use various methods to achieve the described functions for each specific application, but such achievement should not be understood as beyond the protection scope of the present disclosure.

Embodiments of the present disclosure also provide a system for determining shared channel occupancy time (COT), which includes a communication device serving as a first terminal device in aforementioned method embodiments of FIGS. 2 to 10, and a communication device serving as a second terminal device in aforementioned method embodiments of FIG. 11.

The present disclosure also provides a readable storage medium on which instructions are stored, and when the instructions are executed by a computer, the functions of any of the above method embodiments are achieved.

The present disclosure also provides a computer program product that achieves the functions of any of the above method embodiments when executed by a computer.

The above embodiments can be fully or partially implemented through software, hardware, firmware, or any combination thereof. When implemented using software, the embodiments can be fully or partially implemented in the form of a computer program product. The computer program product includes one or more computer programs. When the computer programs are loaded and executed on the computer, all or part of the processes or functions described in the embodiments of the present disclosure are generated. The computer can be a general-purpose computer, a dedicated computer, a computer network, or other programmable devices. The computer program can be stored in a computer-readable storage medium or transmitted from one computer-readable storage medium to another. For example, the computer program can be transmitted from a website site, a computer, a server, or a data center via wired (such as coaxial cable, optical fiber, digital subscriber line (DSL)) or wireless (such as infrared, wireless, microwave, etc.) communication, to transmit to another website, computer, server, or data center. The computer-readable storage medium can be any available medium that the computer can access, or a data storage device such as a server, a data center, etc. that integrates one or more available media. The available media can be magnetic media (such as floppy disks, hard drives, magnetic tapes), optical media (such as high-density digital video discs (DVDs)), or semiconductor media (such as solid state disks (SSDs)), etc.

Those of ordinary skill in the art can understand that the first, second, and other numerical numbers involved in the present disclosure are only for the convenience of description and differentiation, and are not used to limit the scope of embodiments of the present disclosure, but also indicate an order.

At least one in the present disclosure can also be described as one or more, where more can be two, three, four, or more, which is not limited in the present disclosure. In embodiments of the present disclosure, “first”, “second”, “third”, “A”, “B”, “C”, and “D” can be used to distinguish different technical features described, and the technical features described using “first”, “second”, “third”, “A”, “B”, “C”, and “D” are not distinguished from each other in an order or a magnitude.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the correspondence shown in certain rows may not be configured. For example, appropriate deformation adjustments can be made based on the above table, such as splitting, merging, etc. The names of the parameters shown in the titles of the above tables can also use other names that can be understood by the communication device, and the values or representations of the parameters can also use other values or representations that can be understood by the communication device. When implementing the above tables, other data structures can also be used, such as arrays, queues, containers, stacks, linear tables, pointers, linked lists, trees, graphs, structures, classes, heaps, hash tables, etc.

The term predefined in the present disclosure can be understood as defined, defined in advance, stored, stored in advance, negotiated in advance, configured in advance, solidified in advance, or fired in advance.

Those of ordinary skill in the art can realize that units and algorithm steps of each example described in embodiments of the present disclosure can be implemented in electronic hardware, or a combination of computer software and electronic hardware. Whether these functions are implemented in hardware or software depends on the specific application and design constraints of the technical solution. The skilled person can use different methods to achieve the described functions for each specific application, but such achievement should not be considered as beyond the scope of the present disclosure.

Those skilled in the art can clearly understand that for the convenience and conciseness of the description, the specific working processes of the system, device, and unit described above can refer to the corresponding processes in the above method embodiments, which will not be repeated here.

The above are only specific implementations of the present disclosure, but the protection scope of the present disclosure is not limited to this. Those changes or replacements that can be easily conceived by any skilled person familiar with the technical field within the scope of the present disclosure, should be within the protection scope of the present disclosure. Therefore, the protection scope of the present disclosure should be based on the protection scope of appended claims.

1. A method for determining shared channel occupancy time (COT), applied to an unlicensed frequency band in Sidelink communication and performed by a first terminal device, the method comprising:
determining, based on a condition for sharing COT between terminal devices, whether the first terminal device can share the COT initiated by a second terminal device.

2. The method according to claim 1, wherein determining, based on the condition for sharing COT between terminal devices, whether the first terminal device can share the COT initiated by the second terminal device, comprises:
determining, based on distance information between the first terminal device and the second terminal device, whether the first terminal device can share the COT initiated by the second terminal device.

3. The method according to claim 2, wherein determining, based on the distance information between the first terminal device and the second terminal device, whether the first terminal device can share the COT initiated by the second terminal device, comprises:
receiving second stage Sidelink Control Information (SCI) sent by the second terminal device, wherein the second stage SCI comprises at least a first zone identifier and COT sharing information; and
determining that the first terminal device can share the COT initiated by the second terminal device, wherein an identifier of a zone where the first terminal device is located is the same as the first zone identifier.

4. The method according to claim 2, wherein determining, based on the distance information between the first terminal device and the second terminal device, whether the first terminal device can share the COT initiated by the second terminal device, comprises:
receiving second stage SCI sent by the second terminal device, wherein the second stage SCI comprises at least a second zone identifier;
determining, based on the second zone identifier, a distance between the first terminal device and the second terminal device; and
determining that the first terminal device can share the COT initiated by the second terminal device, wherein the distance is less than a distance threshold or within a pre-configured distance range.

5. The method according to claim 4, wherein determining, based on the second zone identifier, the distance between the first terminal device and the second terminal device, comprises:
determining, based on the second zone identifier, geographic location information of the second terminal device; and
determining, based on geographic location information of the first terminal device and the geographic location information of the second terminal device, the distance between the first terminal device and the second terminal device.

6. The method according to claim 2, wherein determining, based on the distance information between the first terminal device and the second terminal device, whether the first terminal device can share the COT initiated by the second terminal device, comprises:
determining a Reference Signal Receiving Power (RSRP) measurement value of a Demodulation Reference Signal (DMRS) of Physical Sidelink Control Channel (PSCCH)/Physical Sidelink Share Channel (PSSCH); and
determining that the first terminal device can share the COT initiated by the second terminal device, wherein the RSRP measurement value is within a pre-configured power range, or greater than a pre-configured power threshold.

7. The method according to claim 1, wherein determining, based on the condition for sharing COT between terminal devices, whether the first terminal device can share the COT initiated by the second terminal device, comprises:
determining, based on resource pools where the terminal devices are located, whether the first terminal device can share the COT initiated by the second terminal device.

8. The method according to claim 7, wherein determining, based on the resource pools where the terminal devices are located, whether the first terminal device can share the COT initiated by the second terminal device, comprises:
determining that the first terminal device can share the COT initiated by the second terminal device, wherein a first resource pool where the first terminal device is located is the same as a second resource pool where the second terminal device is located.

9. The method according to claim 1, wherein determining, based on the condition for sharing COT between terminal devices, whether the first terminal device can share the COT initiated by the second terminal device, comprises:
determining whether the first terminal device is a destination terminal device of the second terminal device; and
determining that the first terminal device can share the COT initiated by the second terminal device, wherein the first terminal device is the destination terminal device of the second terminal device.

10. The method according to claim 1, wherein determining, based on the condition for sharing COT between terminal devices, whether the first terminal device can share the COT initiated by the second terminal device, comprises:
determining, based on a service type of the first terminal device, whether the first terminal device can share the COT initiated by the second terminal device.

11. The method according to claim 10, wherein determining, based on the service type of the first terminal device, whether the first terminal device can share the COT initiated by the second terminal device, comprises:
determining that the first terminal device can share the COT sent by the second terminal device, wherein the service type of the first terminal device is a target service type,
wherein the target service type comprises at least any of a unicast service, a multicast service, or a broadcast service.

12. The method according to claim 1, wherein determining, based on the condition for sharing COT between terminal devices, whether the first terminal device can share the COT initiated by the second terminal device, comprises:
determining, based on types of channels to which information sent by the terminal devices belongs, whether the first terminal device can share the COT initiated by the second terminal device.

13. The method according to claim 12, wherein determining, based on the types of the channels to which the information sent by the terminal devices belongs, whether the first terminal device can share the COT initiated by the second terminal device, comprises:
determining that the first terminal device can share the COT initiated by the second terminal device, wherein a type of a channel to which information sent by the first terminal device belongs is the same as a type of a channel to which information sent by the second terminal device belongs.

14-26. (canceled)

27. A communication device applied to an unlicensed frequency band in Sidelink communication, comprising:
a processor; and
a memory storing instructions executable by the processor,
wherein the processor is configured to:
determine, based on a condition for sharing channel occupancy time (COT) between terminal devices, whether a first terminal device can share the COT initiated by a second terminal device.

28. A non-transitory computer-readable storage medium having instructions stored thereon, which when executed by at least one processor, are configured to execute the method according to claim 1.

29. The communication device according to claim 27, wherein the processor is further configured to:
determine, based on distance information between the first terminal device and the second terminal device, whether the first terminal device can share the COT initiated by the second terminal device.

30. The communication device according to claim 27, wherein the processor is further configured to:
determine, based on resource pools where the terminal devices are located, whether the first terminal device can share the COT initiated by the second terminal device.

31. The communication device according to claim 27, wherein the processor is further configured to:
determine whether the first terminal device is a destination terminal device of the second terminal device; and
determine that the first terminal device can share the COT initiated by the second terminal device, wherein the first terminal device is the destination terminal device of the second terminal device.

32. The communication device according to claim 27, wherein the processor is further configured to:
determine, based on a service type of the first terminal device, whether the first terminal device can share the COT initiated by the second terminal device.

33. The communication device according to claim 27, wherein the processor is further configured to:
determine, based on types of channels to which information sent by the terminal devices belongs, whether the first terminal device can share the COT initiated by the second terminal device.
